(19) United States
(12) Patent Application Publication
(10) Pub. No.: US 2011/0213085 A1
(43) Pub. Date: Sep. 1, 2011

(54) Fluorinated thermoplastic polymer additive

(75) Inventors: Claudio Adolpho Pietro Tonelli, Monza (Milan) (IT); Grazia Meroni, Lipomo (CO) (IT)

(73) Assignee: SOLVAY SOLEXIS S.P.A., Bollate (MI) (IT)

(21) Appl. No.: 13/126,370

(22) PCT Filed: Oct. 23, 2009
(86) PCT No.: PCT/EP2009/064010

§ 371 Date: Apr. 27, 2011

(30) Foreign Application Priority Data
Oct. 28, 2008 (IT) MI2008A001900

(51) Int. Cl. C08L 77/06; C08L 67/02; C08L 75/04

(52) U.S. Cl. 525/184; 525/432; 525/444; 525/458

(57) ABSTRACT

The invention pertains to the use of certain fluorinated thermoplastic polymer additives for reducing the coefficient of friction of non-fluorinated polymers and to masterbatches of said additives with non-fluorinated polymers.

The present invention relates to the use of polymers comprising (per)fluoropolyether segments as additives for hydrogenated polymers to give them good surface properties, in particular a low coefficient of friction.

More specifically the present invention relates to masterbatches comprising thermoplastic block polymers additives comprising (per)fluoropolyether segments and non-fluorinated chains and having at least one melting point (Tm) of at least 25° C. attributable to the non-fluorinated phase, and hydrogenated resins, wherein the concentrations of additive can even be very high, of the order of 50 wt. % or even higher, and wherein said masterbatches can be manufactured using simple equipment and methods.

The use of fluorinated products for improving the surface characteristics of non-fluorinated hydrogenated polymers is known in the prior art. Generally the fluorinated products are applied superficially on the finished article. As an alternative the fluorinated compounds are used as additives to be mixed with the hydrogenated polymers to improve both their surface characteristics and their processability. This second route is generally preferred as it guarantees permanence of the fluorinated additives even in harsh service conditions. In fact, coatings might suffer chemical or mechanical degradation, for example detachment from the polymer substrate.

U.S. Pat. No. 4,278,776 describes the use of polyamides, obtained by polycondensation of bifunctional amines with perfluoropolyether dicarboxylic acids, as additives for improving the flowability of fluorinated rubber compounds and their removal from the mould.

U.S. Pat. No. 5,061,759 describes liquid perfluorinated perfluoropolyethers, optionally containing bromine in the end group, for use as additives for fluorinated rubbers vulcanizable by the peroxide process, the amount of additive being between 0.5 and 1 wt. %. These additives improve the processability of the fluorinated rubbers and removal from the moulds.

The two patents cited above do not describe the use of said perfluoropolyether compounds as additives for hydrogenated polymers for reducing their coefficient of friction. Nor is there any mention of masterbatches of the perfluoropolyether compounds with hydrogenated resins.

U.S. Pat. No. 5,143,963 and U.S. Pat. No. 5,286,773 describe fluorinated additives for hydrogenated thermoplastic polymers capable of endowing the corresponding manufactured articles with surface tension lower than that of the thermoplastic polymer without additive, greater hydrophobicity, non-stick properties, lower friction and a smoother surface. There is no mention of the possibility of preparing masterbatches with high concentrations of additive, for example of the order of 50 wt. %.

Patent application WO 99/23,149 describes the production of articles that are resistant to squeaking using amounts between 0.01 and 5 wt. % of a fluorinated additive in the form of oil, grease or rubber, to be mixed with a hydrogenated polymer, such as polyurethanes or thermoplastic or thermosetting resins. Masterbatches with high concentrations of additive, for example of the order of 50 wt. %, are not mentioned.

Patent application WO 99/23,148 describes abrasion-resistant articles obtained from thermosetting resins by adding, in amounts between 0.01 and 1 wt. %, one of the fluorinated additives described in patent application WO 99/23,149 described above. This patent application does not describe masterbatches.

Patent application WO 99/23,147 describes linear or crosslinked polymers with Shore A hardness from 10 to 90, modified with fluorinated additives in an amount between 1 and 10 wt. %, to obtain improved abrasion resistance. Masterbatches are not described in this patent application either.

The prior art cited above describes fluorinated additives as process additives or for imparting improved surface properties to the finished product. The procedure for introducing the additives is complex owing to the need to use special feeders, for example heated feeders, and high-efficiency mixers such as twin-screw extruders. With the liquid, grease or rubber fluorinated additives of the prior art it is possible to prepare homogeneous masterbatches only with low concentrations of additive, of the order of 1-2 wt. %. This is due to the substantial immiscibility of the (per)fluoropolyether additive in the hydrogenated polymers. When the additive is used at higher concentrations, inhomogeneous masterbatches are obtained. These have the disadvantage that they result in products being obtained that do not have reproducible properties.

In every case, the prior art described does not state the coefficient of friction of the polymers with additives, nor the preparation of masterbatches of the additive with hydrogenated polymers at high content of additive, greater than 10% and up to 50% or even higher.

It is also known that one of the desired properties in thermoplastic polymers is a low coefficient of friction (CoF). Fluorinated additives that are able to lower the CoF of hydrogenated thermoplastic polymers and enable preparing masterbatches even with high concentrations of additive, above 20%, even of the order of 50% or higher, using simple mixing processes, are not described in the prior art cited above.

There was therefore felt to be a need for fluorinated additives having the following combination of properties:
ability to endow hydrogenated polymers and the articles obtained from them with a reduction of the coefficient of friction, preferably greater than 25%, relative to the hydrogenated polymer as such and maintain said properties over time,
availability in solid form, as granules or pellets, which can be fed with normal feeders (hoppers), thus not requiring the use of special feeders, for example those for liquids, possibly heated, reducing the phenomenon of excessive exudation that is typical of fluorinated liquid additives; ready compatibility with hydrogenated thermoplastic polymers able to give masterbatches with high concentrations of additive, preferably above 10%, more preferably above 20%, even up to 50% or higher, also using simple mixing equipment;
possibility of having a chemical structure similar to that of the hydrogenated polymer to which it is to be added, to ensure improved compatibility with the hydrogenated polymer without altering its bulk properties;
thermal stability and melting point similar to those of the hydrogenated polymers to be modified, but in a very wide temperature range, with the melting point preferably varying from 25° C. to temperatures above 300° C.

The applicant found, surprisingly and unexpectedly, a class of fluorinated thermoplastic polymer additives that permit the technical problem described above to be solved.

One object of the present invention relates to the use of fluorinated thermoplastic polymer additives for reducing the coefficient of friction of non-fluorinated (hydrogenated) polymers, said additives comprising (per)fluoropolyether segments and hydrogenated non-fluorinated chain segments, the latter having at least one crystalline phase that melts at a temperature of at least 25° C., preferably of at least 50° C., said additives being obtainable by a reaction of polycondensation, polyaddition in stages or polyaddition of the following components:
a) a (per)fluoropolyether having two functional end groups able to give reactions of condensation, addition in stages or addition with hydrogenated co-reactants,
b) a hydrogenated co-reactant comprising alkylene, cycloaliphatic, aromatic chains, having functional end groups capable of reacting with the functional groups of the (per)fluoropolyether a) to give polymers having at least one hydrogenated crystalline phase having a melting point of at least 25° C.

A mixture of (per)fluoropolyethers with various functional groups can be used as component a). The functional groups are preferably of the same type.

In component b) the alkylene, cycloaliphatic, aromatic chains are optionally combined with one another, and the hydrogen atoms can optionally be replaced with chlorine and/or fluorine atoms up to approx. 30 wt. %, preferably up to 20%. Optionally said chains contain heteroatoms.

As stated, component b), when it reacts with component a), must be such as to lead to the formation of at least one hydrogenated block with a melting point above or equal to 25° C. This results in a polymer being obtained that is solid at room temperature, generally around 25° C.

The additive preferably does not contain hydrogenated polymer segments.

The (per)fluoropolyether a) preferably has the formula

T1-(R1ₕ)ₓ₁R_{f}(R2ₕ)_{x1′}-T2 (Ia)

in which
x₁ and x_{1′}, which may be identical or different, are integers 0 or 1;
R_{f} is a (per)fluoropolyether chain comprising one or more (per)fluorooxyalkylene units;
R1ₕ, R2ₕ, which may be identical or different, represent a cycloaliphatic radical with 3 to 20 carbon atoms, optionally substituted; or an alkylene radical with 1 to 20 carbon atoms, linear or branched; said radicals optionally containing one or more heteroatoms, preferably O, N, S; or one or two aromatic groups, optionally substituted, optionally condensed, optionally bound to the alkylene radicals described above;
T1, T2 are functional groups able to give reactions of condensation or addition, or addition in stages, with component b). Preferably T1 and T2 are identical to one another; more preferably they are selected from —OH, —COOH, —COOR, —NH₂, —NCO, —CN, —CHO, —CH═CH₂, —SH, epoxide.

Rf comprises one or more of the following units, distributed randomly along the chain, selected from: (C₃F₆O); (CFYO) in which Y is F or CF₃; (C₂F₄O); (CF₂(CF₂)_{x′}CF₂O) where x′ is an integer equal to 1 or 2; (CR₄R₅CF₂CF₂O) in which R₄ and R₅, which may be identical or different, are selected from H, Cl, (per)fluoroalkyl having, for example, from 1 to 4 carbon atoms.

Rf preferably has a number-average molecular weight between 500 and 10000, more preferably 900-3000.

Preferably the (per)fluoropolyethers a) comprise structures selected from the following:

—CF₂—O—(CF₂CF₂O)_{p′}(CF₂O)_{q′}—CF₂— (a′)
where p′ and q′ are integers such that the number-average molecular weight is within the range stated above, and q′ can also be equal to 0; when p′ is different from zero, the ratio q′/p′ is between 0.2 and 2;

—CFX′^{I}—O—(CF₂CF(CF₃)O)_{r′}—(CF₂CF₂O)_{s′}—(CFX′^{I}O)_{t′}—CFX′^{I}— (b′)
where X′^{I} is —F or —CF₃; r′, s′ and t′ are numbers such that t′/(r′+s′) is between 1 and 50, the ratio t′/(r′+s′) is between 0.01 and 0.05, (r′+s′) being different from zero, the number-average molecular weight is within the range stated above;

—CF(CF₃)(CFX′^{I}O)_{t′}(OC₃F₆)_{u′}—OR′_{f}O—(C₃F₆O)_{u′}(CFX′^{I}O)_{t′}CF(CF₃)— (c′)
where R′_{f} is a C₁-C₈ perfluoroalkylene; (u′+t′) is a number such that the number-average molecular weight is within the range stated above; t′ can also be equal to zero; X′^{I} is as stated above;

—CF₂CF₂O—(CF₂(CF₂)_{x′}CF₂O)_{v′}—CF₂CF₂ (d′)
where v′ is a number such that the number-average molecular weight is within the range stated above, x′ is an integer equal to 1 or 2;

—CF₂CH₂—(OCF₂CF₂CH₂O)_{w′}—OR′_{f}O—(CH₂CF₂CF₂O)_{w′}—CH₂CF₂ (e′)
where R′_{f} is a C₁-C₈ perfluoroalkylene; w′ is a number such that the number-average molecular weight is within the range stated above.

The (per)fluoropolyethers having structure (a′)-(e′) are known products and can be prepared starting from the corresponding (per)fluoropolyoxyalkylenes having —COF end groups. See, for example, patents GB 1,104,482, U.S. Pat. No. 3,715,378, U.S. Pat. No. 3,242,218, U.S. Pat. No. 4,647,413, EP 148,482, U.S. Pat. No. 4,523,039, EP 340,740, WO 90/03357, U.S. Pat. No. 3,810,874, EP 239,123, U.S. Pat. No. 5,149,842, U.S. Pat. No. 5,258,110.

A mixture of different (per)fluoropolyethers having formula (Ia) can be used as component a).

Component a) can be used mixed with monofunctional (per)fluoropolyethers (PFPE). These have formula (Ia) in which x1=0 and T1 is F, C₁-C₃ perfluoroalkyl. Generally the molar percentage of monofunctional unit in component a) can be up to approx. 30%, but is preferably less than 10%. The monofunctional (per)fluoropolyethers are prepared according to known methods, for example by photooxidation of hexafluoropropene according to the method described in patent GB 1,104,482; or by ionic telomerization of hexafluoropropene epoxide, see for example U.S. Pat. No. 3,242,218; by photooxidation of mixtures of C₃F₆ and C₂F₄ by the processes described in U.S. Pat. No. 3,665,041.

Component b) preferably has the formula

T-(Rₕ)_{y1}R_{y}(Rₕ)_{y1′}-T′ (I)

in which
T and T′, which may be identical or different, preferably identical, are functional groups, preferably selected from:
   —NHR₁ where R₁ is H, linear or branched C₁-C₅ alkyl; benzyl or phenyl, optionally substituted;
   —NCO, —OH, —COOR where R is a linear or branched alkyl radical with from 1 to 5 carbon atoms, anhydride;
Rₕ is a linear or branched C₁-C₂₀ alkylene chain, or C₃-C₂₀ cycloaliphatic chain, or an aromatic radical, optionally substituted;
R_{y} is a C₃-C₂₀ cycloaliphatic chain, optionally substituted, a linear or branched C₁-C₂₀ alkylene chain, one or two aromatic groups, optionally substituted, optionally condensed, optionally bound to alkylene segments containing between 1 and 12 carbon atoms, optionally containing heteroatoms, preferably O, N, S;
y₁ and y_{1′}, which may be identical or different, are integers equal to 0 or 1.

Component b) can be foamed from a mixture of compounds of formula (I).

Non-fluorinated hydrogenated compounds having functional groups that are not reactive with component a) but are able to react with those of component b) and form a compound that is able to react with component a), can be mixed with component b).

Component b) can be used mixed with non-fluorinated monofunctional hydrogenated compounds. The latter can have, for example, the structure of formula (I) in which T is equal to H or alkyl. Generally the molar percentage of monofunctional compounds can be up to approx. 30%, but is preferably less than 10%.

Examples of component b) are as follows:

(A) diamines of formula:

NHR_{3′}—(Rₕ)_{y1}—R_{y}—(Rₕ)_{y1′}—NHR₃ (1)
in which y1, y1′ are integers equal to 0 or 1;
R₃, R_{3′}, which may be identical or different, can be H, linear or branched C₁-C₅ alkyl radical;
Rₕ, R_{y} are as defined above.

Preferred diamines are 1,12-diamine dodecane, p-xylylenediamine, 1,4-phenylenediamine, 1,5-naphthalenediamine, 1,2-bis(4-methoxyphenyl)diaminoethane, 1,6-hexamethylenediamine.

(B) Isocyanates of formula:

OCN—R_{y}—NCO

in which R_{y} is as defined above in formula (I).

The preferred bifunctional hydrogenated isocyanates are methyl diphenyldiisocyanate (MDI), phenylenediisocyanate, 1,5-naphthalene diisocyanate, bis-tolylenediisocyanate, cyclohexyldiisocyanate (CHDI), methylenedicyclohexylene diisocyanate (H₁₂MDI), hexamethylenediisocyanate (HDI).

(C) Esters of formula:

ROOC—R_{y}—COOR (2)

in which R and Ry are as defined in formula (I).

(D) Alcohols (diols) of formula

HO—R_{y}—OH (5)

in which Ry is as defined in formula (I).

The preferred hydrogenated diols are 1,2-dodecanediol, 1,2-tetradecanediol, 1,2-octanediol, poly(1,4-butanediol), 1,2-dihydroxynaphthalene, 1,14-tetradecanediol, 1,4-butanediol (BDO).

(E) Anhydrides of formula

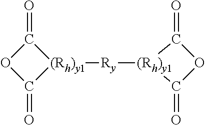

in which Rₕ, R_{y}, y₁, y₁′ are as defined in formula (I).

Preferred anhydrides are pyromellitic anhydride, phthalic anhydride, etc.

Preferred monofunctional amines are octadecyl amine, N-methyl octadecyl amine, dodecylamine, 1-aminohexadecane.

A preferred monofunctional isocyanate is cyclohexyl isocyanate.

A melting point of at least 25° C. of at least one hydrogenated phase of the additive is obtainable using components b) that have a melting point above 25° C. Components b) that are particularly preferred comprise structures constituted of:
one or more aromatic or cyclic rings having substituents in the para position;
linear alkylene chains with at least 12 carbon atoms;
presence of groups able to give strong hydrogen bonds, for example amides and/or urethanes.

The additives of the present invention generally have a molecular weight between 3000 and 200 000, preferably between 5000 and 50000.

In general the hydrogenated portion of the additive is at least 5 wt. %, preferably between 10% and 50%, more preferably between 10% and 20%.

The processes for preparing the additive comprise reactions of polycondensation, polyaddition in stages or polyaddition. See, for example, Journal Applied Polymer Science, 2003, Vol. 87, pages 2279-2294. In particular, the additives are obtainable, for example, by a process that comprises the following phases:
1) reaction of condensation or addition between the functional groups of the (per)fluoropolyether (component a)) with those of the hydrogenated co-reactant (component b)), at a temperature generally between 20° C. and 200° C., operating with a ratio in equivalents between the reactive functional groups of compounds a) and those of component b) between 0.25 and 4;
2) removal of any reaction by-products, for example water, alcohols and solvents, if present;
3) isolation of the product obtained in the form of a polymer that is solid at room temperature of approx. 25° C. and has a melting point of at least one hydrogenated crystalline phase contained in the polymer of at least 25° C.

Component a) can optionally be constituted of a mixture of different (per)fluoropolyethers. Component b) can optionally be constituted of a mixture of different compounds b). Phase 1) can optionally be carried out in the presence of catalysts belonging, for example, to the class of acids or of bases, organic and inorganic, to the class of organometallic compounds, or to the class of organic peroxides.

Examples of preparation of some classes of additives will be presented, for purposes of illustration.

### Polyurethane Additives

Embodiment 1 is as Follows.

A (per)fluoropolyether with hydroxyl end groups (component a)) is reacted with an excess of hydrogenated diisocyanate (component b)), optionally in the presence of a metallic catalyst, for example dibutyltin dilaurate (DBTDL).

It is left to react at a temperature between 20° C. and 100° C. until titration of the residual isocyano groups shows that all hydroxyl groups have reacted. Optionally a chain extender is added, preferably a component d) mentioned above, such as butanediol, hydroquinone ethoxylate (HQE).

It is left to react until the mixture becomes a very viscous liquid, preferably having a viscosity>20000 cPs at room temperature. The product obtained is discharged into a mould to complete the polymerization in the press at a temperature generally between 90° C. and 150° C., for a time of the order of some hours. A fluorinated thermoplastic polymer is obtained with a melting point that depends on the chemical structure of components a) and b) used and on their ratio in equivalents.

An alternative process for preparing polyurethane additives comprises the reaction of a non-fluorinated macromer containing hydroxyl groups, for example polytetramethyleneglycol diol (PTMEG), polycaprolactone diol (PCL), with an excess of hydrogenated diisocyanate, optionally in the presence of metallic catalysts, for example dibutyltin dilaurate (DBTDL).

It is left to react at a temperature generally between 20° C. and 100° C. until titration of the residual isocyano groups shows that all the hydroxyl groups have reacted. Then the bifunctional component a) with hydroxyl functionality is added. Then the procedure described in embodiment 1 is followed.

### Polyamide Additives

A non-fluorinated diamine (component b)) is reacted with a (per)fluoropolyether with ester or carboxyl functionality (component a)), in an amount in equivalents of amino groups equal to that of the functional groups of component b) or in excess, at a temperature preferably between 40° C. and 200° C., preferably for a time between a few minutes and several hours. The volatile reaction by-products are removed. The product is discharged into a mould and moulded at a temperature that depends on the reactants used and on the relative proportions. Generally the temperature is between 50° C. and 250° C.

### Polyamide-Imide Additives

A diamine (component a)) is reacted with component b) with ester or carboxyl functionality in an amount that is deficient relative to component a).

It is left to react at a temperature preferably between 40° C. and 200° C., preferably removing the volatile reaction by-products, until IR analysis no longer shows the absorption band at 1790-1800 cm⁻¹ of the ester/carboxyl groups of component a). A non-fluorinated hydrogenated anhydride (component b)) is added in an amount equal to the residual amino groups. It is left to react at a temperature preferably between 100° C. and 300° C. for a time preferably between a few minutes and several hours. The polymer is discharged into a mould and the procedure is followed as for the polyamide additives.

### Polyimide Additives

A non-fluorinated bifunctional hydrogenated anhydride (component b)) is reacted with a (per)fluoropolyether with amino functionality (component a)), at a temperature preferably between 40° C. and 200° C., for a time preferably from a few minutes to several hours, removing the volatile reaction by-products. The polymer is discharged into a mould and the procedure as described in the synthesis of the polyamide additives is followed.

### Polyester Additives

A non-fluorinated hydrogenated dicarboxylic/diester compound is reacted with a hydrogenated diol in such a way that the moles of the latter are deficient relative to those of the diacid/diester. Reaction is continued at a temperature preferably between 100° C. and 200° C., until the hydroxyl groups of the hydrogenated diol can no longer be detected in ¹H-NMR analysis, preferably in the presence of a metallic catalyst, removing the reaction by-products. Then the (per)fluoropolyether with alcoholic functionality (component a)) is added and it is reacted at a temperature preferably between 150° C. and 200° C. until the ester groups or the acid groups can no longer be determined in ¹H-NMR analysis. The polymer is discharged into a mould and the procedure described for the polyamide additives is followed.

The applicant found, unexpectedly and surprisingly, that the thermoplastic additives of the present invention are able to endow hydrogenated resins with low coefficients of friction. The coefficient of friction is generally of the order of approx. 25% relative to that of the hydrogenated polymer without additive. This reduction is maintained over time.

The additives of the invention display the phenomenon of migration or exudation typical of the fluorinated additives that are liquid at room temperature to a lesser extent, and have extremely low vapour pressure. This constitutes an advantage relative to the non-polymeric additives known in the prior art, since the weight losses of additive are lower at the temperatures of processing and use.

It was also found, unexpectedly and surprisingly, that the additives of the present invention make it possible to obtain homogeneous masterbatches with hydrogenated resins even at high concentrations of additive, of the order of 50 wt. % or even higher.

Therefore a further object of the present invention relates to masterbatches of hydrogenated resins with the fluorinated thermoplastic additives of the invention.

The hydrogenated resins of the masterbatch are (non-fluorinated) hydrogenated thermoplastic polymers. Polymers are preferably obtained by polyaddition such as polyolefins, for example polyethylene, polypropylene; polymers obtained by polyaddition in stages such as the polyurethanes; polymers obtained by polycondensation such as polyesters, polyamides, polyamide-imides, polyimides, etc. As polyamides we may mention, for example, PA6, PA66, PA12; as polyesters we may mention, for example, polyethylene terephthalate (PET), polybutylene terephthalate (PBT).

The amount of thermoplastic additive in the masterbatch is between 0.5 and 50 wt. %, or more. Preferably the additive is greater than or equal to 5 wt. %, more preferably to 10%, even more preferably to 20%, and most preferably to 30%.

The masterbatches can optionally contain other fluorinated compounds such as oils, rubbers or greases. In this connection see U.S. Pat. No. 5,143,963, U.S. Pat. No. 5,286,773. Preferably (per)fluoropolyether oils with perfluoroalkyl or functional (reactive) end groups are added.

Examples of masterbatch compositions (wt. %) are:

| | |
|---|---|
| thermoplastic additive | 5-50% |
| hydrogenated polymer | 50-95% |
| fluorinated compounds | 0-10%, pref. 0-5% |
| (oil and/or grease and/or rubber) | |

the sum of the components of the masterbatch being equal to 100 wt. %.

In the preparation of the masterbatches, the additive used is generally such as to have a melting point below the temperature of the process used for preparation of the masterbatch.

The masterbatches can also be obtained with simple methods and equipment. It is possible to use, for example, single-screw extruders in which the hydrogenated polymer with additive is fed in the hopper, in the form of powder, pellets, granules, optionally in the presence of fluorinated compounds (oils and/or greases and/or rubbers). It is extruded according to known methods. It is possible to feed the single-screw extruder by introducing the hydrogenated polymer and the fluorinated thermoplastic additives of the invention separately, in two separate hoppers, optionally in the presence of the fluorinated compounds stated above.

Instead of the single-screw extruder it is possible to use a mixer, for example of the Brabender type, in which the fluorinated thermoplastic additive is mixed with the hydrogenated polymer, optionally in the presence of the fluorinated compounds stated above.

As stated, the fluorinated thermoplastic additives of the invention make it possible to prepare masterbatches even with high concentrations of additive, of the order of 50% or more. From the industrial standpoint this leads to the following advantages:
considerable reduction of the volumes of masterbatch to be prepared, stored and handled, with notable reduction of total processing costs,
reduction of the amount of hydrogenated polymer to be used in the preparation of the masterbatch.

Therefore in the final modified polymer, at equal amounts of fluorine introduced, the possible negative effects associated with the presence of two different hydrogenated polymeric structures, the hydrogenated polymer (host polymer) and the hydrogenated polymer of the masterbatch, are reduced.

Another advantage of the additives of the present invention is the possibility of preparing a considerable number of different masterbatches depending on the hydrogenated portion of the thermoplastic additive. The latter can be selected so as to have the same chemical structure as the hydrogenated polymer of the masterbatch. This makes it possible to obtain modified hydrogenated polymers having a single hydrogenated backbone. Consequently there are no unwanted and uncontrolled variations of the bulk properties and surface properties of the finished product. This represents a notable industrial advantage.

A further advantage of the thermoplastic additives of the invention is to permit masterbatches to be prepared by adding the fluorinated additive to the hydrogenated polymer with simple methods, for example using single-screw extruders, without requiring the use of special feeders or mixers. This is advantageous as it permits a significant cost reduction relative to the more complex twin-screw extruders.

The masterbatches of the invention are macroscopically homogeneous. This makes it possible to obtain homogeneous articles.

The polymer materials and articles obtainable from the masterbatches of the invention constitute a further object of the present invention.

The amount of additive in the hydrogenated polymers (host polymer+polymer of the masterbatch) is generally between 0.1% and 10 wt. %, preferably between 0.5% and 5%, more preferably between 1% and 2%.

As stated, the polymer materials and the articles are obtainable by adding the masterbatch to the hydrogenated polymers and then processing by known methods, for example injection moulding, compression moulding.

The articles containing the additives of the present invention display a low coefficient of friction, in particular lower than the polymers without the additive.

The additives of the present invention are also able to endow the hydrogenated host polymer and the manufactured article with properties of water-repellence and oil-repellence.

Some examples now follow, which illustrate but do not limit the invention.

### EXAMPLES

### Characterization

### Amine Equivalent Weight

This is determined by potentiometric titration, by dissolving approx. 5 g of polymer in a 9:1 (v/v) H-GALDEN® Grade A fluoropolyether fluid:methanol solution and titrating with an alcoholic solution of 0.1N HCl.

### Melting Point

This is determined by calorimetry. The thermal transitions (Tm) were determined with a Perkin Elmer® DSC instrument using three successive heatings with a gradient from −170° C. to +250° C. at a rate of 20° C./min. At the start and after each heating phase, the equipment is cooled at a rate of 80° C./min.

### Static Contact Angle

This is determined by the stationary drop method with a Kruss® G23 instrument at room temperature vs hexadecane and water. The angle is measured on a photograph taken after 30 seconds of contact of the drop with the surface.

The higher the contact angle, the greater is the repellence with respect to the liquid used.

### Coefficient of Friction (CoF)

This is determined at 23° C. according to ASTM standard D1894, using as contact surface a square steel plate with an area of 625 mm², with applied force of 11.79N and a pulling speed of 100 mm/min.

The lower the CoF, the lower the friction of the surface.

### Molecular Weight and Structure of the Additives

These are both determined by NMR, either ¹H-NMR or ¹⁹F-NMR. These analyses are carried out using an INOVA® 400 instrument following the procedure described in “Macromolecules” 1995, Vol. 28, 7271-7275 Turri, Barchiesi, Levi.

### NCO Titre

This is determined according to ASTM standard D-2572, using THF and hydrochloric acid dissolved in isopropanol.

### Acid Number

This is determined by method ASTM D-1639. The acid number is expressed as mg KOH/g polyester.

### Ester Groups Converted

These are determined by IR analysis from the absorption band at 1792 cm⁻¹ of the ester group.

### Examples of Preparation of the Additive

### Example 1

### Preparation of a Polyamide Additive by Reacting a C₁₂ Aliphatic Diamine and PFPE Diester

25.08 g (0.125 mol) of 1,12-diaminododecane and 187.5 g (0.125 mol) of perfluoropolyether diester having a number-average molecular weight of 1500 of formula:

CH₃CH₂OCOCF₂O(CF₂CF₂O)ₚ(CF₂O)CF₂COOCH₂CH₃ with p/q=2

are fed into a 500-ml polycondensation reactor equipped with a stirrer.

The reaction mixture is heated in a nitrogen atmosphere for 4 hours at 90° C., distilling off the ethanol produced by the reaction. The reactor is then connected to a vacuum pump (1 mmHg) and heated at 100° C. for 4 hours. At the end the initial pressure is restored by introducing nitrogen and the product is discharged while hot.

The IR absorption spectrum of the polymer obtained does not have the absorption band at 1792 cm⁻¹ of the —CF₂COOCH₂CH₃ group. This confirms that all the ester groups of the perfluoropolyether were converted to amide groups (IR absorption band at 1710 cm⁻¹). ¹⁹F-NMR and ¹H-NMR analysis confirms the polyamide structure of the polymer obtained.

A first-order transition (melting point) at 25° C. is determined by calorimetric analysis.

### Example 2

Preparation of a Polyamide Additive by Reacting a C₁₂ Aliphatic Diamine with PFPE Diester and with Stearyl Amine

Example 1 is repeated but using 13.73 g (0.069 mol) of 1,12-diaminododecane and 187 g (0.094 mol) of α,ω-perfluoropolyether diester as component a), which has a number-average molecular weight of 2000.

After the reaction mixture has reacted for 4 hours at 90° C., distilling off the ethanol produced by the reaction, 12.37 g (0.049 mol) of stearyl amine is added. It is left to react for a further 4 hours at 90° C. Then the procedure described in example 1 is followed.

The IR spectrum of the polymer obtained does not have the absorption band at 1792 cm⁻¹ of the —CF₂COOCH₂CH₃ group, confirming that all the ester groups of the starting perfluoropolyether were converted to amide groups.

¹⁹F-NMR and ¹H-NMR analyses confirm the polyamide structure of the polymer obtained.

A melting peak at 55° C. is determined by calorimetric analysis.

### Example 3

Preparation of a Polyester Additive by Reacting Dodecanedioic Acid with 1,12-dodecanediol and with PFPE Diol

28.75 g (0.125 mol) of dodecanedioic acid and 16.63 g (0.082 mol) of 1,12-dodecanediol were fed into a 250-ml polycondensation reactor equipped with a stirrer. 0.8 g of FASCAT™ 4100 was also fed into the reactor as catalyst.

The reaction mixture is heated in a nitrogen stream for 5 hours at 150° C., distilling off the water of reaction that forms. When ¹H-NMR analysis shows that the hydrogenated alcohol has been completely converted to ester, 64.5 g (0.043 mol) of ethoxylated perfluoropolyether dialcohol (PFPE diol) is added, with a number-average molecular weight of 1500 and having the following structure:

H(OCH₂CH₂)ₙOCH₂CF₂O(CF₂CF₂O)ₚ(CF₂O)_{q}CF₂CH₂—O—(CH₂CH₂O)ₙH

and with p/q=2, n=1.8.

It is left to react for 23 hours at 170° C. in a nitrogen stream for complete conversion of the ethoxylated perfluoropolyether dialcohol to ester. The acid number is 5 mg KOH/g of polymer.

¹⁹F-NMR and ¹H-NMR analyses confirm the polyester structure of the polymer obtained.

The presence of a melting peak at 57° C. is determined by calorimetric analysis.

### Example 4

Preparation of an Additive with Polyamide-Imide Structure by Reacting a C₆ Diamine with a PFPE Diester and with Pyromellitic Anhydride

A 250-ml polycondensation reactor equipped with a stirrer is charged with 8.66 g (0.075 mol) of 1,6-hexamethylenediamine and 100 g (0.067 mol) of perfluoropolyether diester the same as in example 1.

It is heated in a nitrogen atmosphere for 4 hours at 90° C., distilling off the ethanol that forms. At the end of the 4 hours, the reactor is connected to a vacuum pump (1 mmHg) and heated at 100° C. for 4 hours. Then the initial pressure is restored with nitrogen.

The IR spectrum of the polyamide polymer obtained does not show the absorption band at 1792 cm⁻¹ typical of the —CF₂COOCH₂CH₃ groups, confirming that all the ester groups of the starting perfluoropolyether were converted to amide groups. The amine equivalent weight is 6750 g/eq.

Then 1.74 g (0.008 mol) of pyromellitic anhydride is added at 100° C. and it is left to react for one hour at 100° C. A polymer polyamide is obtained bearing acid groups pendent from the backbone. ¹H-NMR analysis and direct titration with n-butylamine confirm the presence of acid groups.

The reactor is connected to a vacuum pump (1 mmHg) and is heated at 150° C. and it is left to react for 4 hours. The polymer obtained shows a polyamide-imide structure as shown by ¹⁹F-NMR and ¹H-NMR analyses.

The presence of a melting peak at 93° C. is determined by calorimetric analysis.

### Example 5

Preparation of an Additive with Polyurethane Structure by Reacting HDI with PFPE Diol and with 1,4-Butanediol

A 250-ml reactor equipped with a stirrer is charged with 22.4 g (0.133 mol) of hexamethylenediisocyanate (HDI) and 100 g (0.067 mol) of perfluoropolyether alcohol (PFPE diol) having a number-average molecular weight of 1500 and with the following structure:

HOCH₂CF₂O(CF₂CF₂O)ₚ(CF₂O)_{q}CF₂CH₂OH with p/q=2

and 0.007 g of dibutyltin dilaurate (DBTDL) as catalyst.

It is heated in a nitrogen atmosphere for 2 hours at 90° C. A polymer is obtained that has a residual content of —NCO groups of 2.27 wt. %.

Then, while stirring, 5.94 g (0.067 mol) of 1,4-butanediol is added at 60° C. The reaction is completed by pouring the reaction mixture into a mould at 90° C. for 12 hours.

The IR spectrum of the polymer obtained does not have the absorption band at 2262 cm⁻¹ of the —NCO group, confirming that all the —NCO groups of HDI have been converted to urethane groups, which show an absorption band at 1723 cm⁻¹.

¹⁹F-NMR and ¹H-NMR analyses confirm the polyurethane structure of the polymer obtained. The presence of a melting peak at 122° C. is determined by calorimetric analysis.

### Example 6

Preparation of an Additive with Polyimide Structure by Reacting PFPE Diamine with Pyromellitic Anhydride

A 250-ml reactor equipped with a stirrer is charged with 14.5 g (0.0067 mol) of pyromellitic anhydride and 100 g (0.067 mol) of perfluoropolyether diamine with a number-average molecular weight of 1500 having the following structure:

NH₂CH₂CF₂O(CF₂CF₂O)ₚ(CF₂O)_{q}CF₂CH₂NH₂ with p/q=2.

It is heated at 100° C. for one hour. ¹H-NMR analysis and titration of the acid groups of the polymer show that the polyamide polymer obtained has acid groups pendent from the backbone. The reactor is connected to vacuum (1 mmHg) and is heated at 180° C. for 4 hours.

The polymer obtained has an imide structure, as shown by ¹⁹F-NMR and ¹H-NMR analyses.

The presence of a melting peak at 95° C. is determined by calorimetric analysis.

### Examples of Preparation of Masterbatches and Use Thereof

Table 1 shows the results of the following determinations carried out on the moulded polymers: contact angle vs water and vs hexadecane, and coefficient of friction (CoF).

### Example 7

Use of the Polyamide Additive from Example 1 for Modifying PA12

20 parts by weight of the additive from Example 1 are mixed in a Brabender at 190° C. for 20 minutes (15 rpm) with 80 parts by weight of PA12.

The masterbatch obtained, at room temperature, is a white, homogeneous plastic material. Next, the masterbatch is ground in a mill at ambient temperature (25° C.).

The masterbatch obtained is then used as an additive in the hydrogenated polyamide PA12 at 1 wt. % and 2 wt. %, respectively, of the additive from Example 1.

Mixing is carried out in a Brabender.

The additive-modified polymers obtained were moulded between sheets of aluminium with a thickness of 0.3 mm in a compression press at 230° C. for 5 minutes.

The PA 12 without additive was moulded in the same conditions.

### Example 8

Use of the Polyether Additive from Example 3 for Modifying Pet

Example 7 is repeated, but using 30 parts by weight of additive from Example 3, 70 parts by weight of PET and a mixer temperature of 250° C.

The masterbatch obtained, at room temperature, is a white, homogeneous plastic material, which is ground in a mill at ambient temperature (25° C.).

The masterbatch obtained was then used as an additive for polyester PET with 1 wt. % of the additive from Example 3, following the procedure in Example 7.

The additive-modified polymer obtained was moulded as in Example 7 but using a temperature of 265° C.

The PET without additive was moulded in the same conditions.

### Example 9

Use of the Polyamide Additive from Example 1 for Modifying Pa 6,6

Example 7 is repeated, but using 50 parts by weight of the additive from Example 1, which are mixed in a single-screw extruder at 265° C. and 50 rpm with 50 parts by weight of PA 6,6.

The masterbatch obtained, at room temperature, is a white, homogeneous plastic material.

The masterbatch was then used as an additive in polyamide PA 6,6 with 1 wt. % of the additive from Example 1 using a single-screw extruder.

The additive-modified polymer obtained was moulded as in Example 7.

The PA 6,6 without additive was moulded in the same conditions.

### Example 10

Use of the Polyamide Additive from Example 2 for Modifying PP

Example 7 is repeated, but using, for preparation of the masterbatch, 30 parts by weight of the additive from Example 1 and 70 parts by weight of PP.

The masterbatch obtained, at room temperature, is a white, homogeneous plastic material, which is then ground in a mill at room temperature.

The masterbatch was then used as an additive in polypropylene PP with 1 wt. % of the additive from Example 2, following the procedure of Example 7.

The polymer obtained was moulded as in Example 7. The PP without additive was moulded in the same conditions.

### Example 11

Use of the Polyurethane Additive from Example 5 for Modifying a Hydrogenated Polyurethane (HPU)

Example 7 is repeated, but using, for preparation of the masterbatch, 30 parts by weight of the additive from Example 5 and 70 parts by weight of HPU (polyurethane based on PTMEG1000/BDO/HDI 1/1/2). The mixer temperature is 140° C.

The masterbatch obtained, at room temperature, is a white, homogeneous plastic material and is ground in a mill at room temperature.

The masterbatch was then used as an additive in the hydrogenated polyurethane HPU with 1 wt. % of the additive from Example 5, following the procedure of Example 7. The polymer obtained was moulded following the procedure of Example 7, but at a temperature of 120° C. HPU without additive was moulded in the same conditions.

### Example 12

Use of the Polyamide-Imide Additive from Example 4 for Modifying PP

Example 7 is repeated, but using, for preparation of the masterbatch, 30 parts by weight of the additive from Example 4 and 70 parts by weight of PP.

The masterbatch, at room temperature, is a white, homogeneous plastic material. The masterbatch is then ground in a mill at room temperature.

The masterbatch was used as an additive in polypropylene PP with 1 wt. % of the additive from Example 4, following the procedure of Example 7.

The polymer was moulded as in Example 7. The PP without additive was moulded in the same conditions.

### Example 13

Use of the Polyimide Additive from Example 6 for Modifying PP

Example 7 is repeated, but using, for preparation of the masterbatch, 15 parts by weight of the additive from Example 6 and 85 parts by weight of PP.

The masterbatch obtained, at room temperature, is a white, homogeneous plastic material. The masterbatch is ground in a mill at room temperature.

The masterbatch is then used as an additive in polypropylene PP with 1 wt. % of the additive from Example 6, following the procedure of Example 7.

The polymer obtained was moulded as in Example 7. The PP without additive was moulded in the same conditions.

TABLE 1

| | | | Additive in | Conc. of | | Tm | Contact angle | Contact angle |
|---|---|---|---|---|---|---|---|---|
| | Hydrogenated | | masterbatch | additive | | additive | vs water | vs hexadecane |
| Example | polymer | Additive | (wt. %) | (wt. %) | CoF | (° C.) | (°) | (°) |
| 7 | PA12 | — | — | — | 0.20 ± 0.07 | — | 86 ± 2 | Wetted completely |
| | PA12 | Ex. 1 | 20 | 1 | 0.08 ± 0.01 | 25 | 100 ± 3 | 47 ± 4 |
| | PA12 | Ex. 1 | 20 | 2 | 0.07 ± 0.01 | 25 | 102 ± 5 | 47 ± 2 |
| 8 | PET | — | — | — | 0.30 ± 0.03 | — | 88 ± 2 | Wetted completely |
| | PET | Ex. 3 | 30 | 1 | 0.15 ± 0.02 | 57 | 113 ± 7 | 45 ± 5 |
| 9 | PA6,6 | — | — | — | 0.30 ± 0.05 | — | 73 ± 2 | Wetted completely |
| | PA6,6 | Ex. 1 | 50 | 1 | 0.22 ± 0.03 | 25 | 80 ± 3 | 36 ± 2 |
| 10 | PP | — | — | — | 0.27 ± 0.03 | — | 95 ± 2 | Wetted completely |
| | PP | Ex. 2 | 30 | 1 | 0.18 ± 0.02 | 55 | 110 ± 2 | 34 ± 2 |
| 11 | HPU | — | — | — | 0.60 + 0.05 | — | 64 ± 5 | 40 ± 5 |
| | HPU | Ex. 5 | 30 | 1 | 0.35 + 0.03 | 122 | 85 ± 5 | 54 ± 5 |
| 12 | PP | Ex. 4 | 30 | 1 | 0.18 ± 0.03 | 93 | 100 ± 2 | 36 ± 5 |
| 13 | PP | Ex. 6 | 15 | 1 | 0.18 ± 0.02 | 95 | 99 ± 2 | 32 ± 5 |

1. A method for reducing the coefficient of friction of non-fluorinated polymers, comprising using a fluorinated thermoplastic polymer additive,
said additive comprising (per)fluoropolyether segments and non-fluorinated hydrogenated chain segments, said non-fluorinated hydrogenated chains having at least one crystalline phase that melts at a temperature of at least 25° C., the additive being obtainable by a reaction of polycondensation, polyaddition in stages, or polyaddition of the following components:
a) a (per)fluoropolyether having two functional end groups able to give reactions of condensation or addition with hydrogenated co-reactants; and
b) a hydrogenated co-reactant containing alkylene, cycloaliphatic, aromatic chains, and having functional end groups capable of reacting with the functional groups of the (per)fluoropolyether a), to give polymers having at least one crystalline hydrogenated phase having a melting point of at least 25° C.

2. The method according to claim 1, wherein the additive has at least one crystalline phase that melts at a temperature of at least 50° C.

3. The method according to claim 1, wherein in component b), the hydrogen atoms of the alkylene, cycloaliphatic, aromatic chains, are substituted with chlorine and/or fluorine atoms up to approximately 30 wt. %, optionally said chains contain heteroatoms.

4. The method according to claim 1, wherein the (per)fluoropolyether a) has the formula (Ia):
T1-(R1ₕ)ₓ₁R_{f}(R2ₕ)_{x1′}-T2 (Ia)
in which
x₁, x_{1′}, which are identical or different, are integers 0 or 1;
R_{f} is a (per)fluoropolyether chain comprising one or more (per)fluorooxyalkylene units;
R1ₕ, R2ₕ, which are identical or different, represent a cycloaliphatic radical with 3 to 20 carbon atoms, optionally substituted, or a linear or branched alkylene radical with 1 to 20 carbon atoms; said radicals optionally containing one or more heteroatoms, one or two aromatic groups, optionally substituted, optionally condensed, optionally bound to the alkylene radicals defined above; and
T1, T2 are functional groups able to give reactions of condensation or addition, or addition in stages with said component b).

5. The method according to claim 4, wherein Rf comprises one or more of the following units distributed randomly along the chain, selected from the group consisting of: (C₃F₆O); (CFYO) in which Y is F or CF₃; (C₂F₄O); (CF₂(CF₂)_{x′}CF₂O) where x′ is an integer equal to 1 or 2; and (CR₄R₅CF₂CF₂O), in which R₄ and R₅, which are identical or different, are selected from the group consisting of H, Cl, and (per)fluoroalkyl with 1 to 4 carbon atoms.

6. The method according to claim 5, wherein Rf has a number-average molecular weight between 500 and 10,000.

7. The method according to claim 6, wherein the perfluoropolyethers a) comprise structures selected from the group consisting of:
—CF₂—O—(CF₂CF₂O)_{p′}(CF₂O)_{q′}—CF₂— (a′)
where p′ and q′ are integers such that the number-average molecular weight is between 500 and 10,000 and q′ is optionally equal to 0; when p′ is different from 0, the ratio q′/p′ is between 0.2 and 2 and the number-average molecular weight is between 500 and 10,000;
—CFX′^{I}—O—(CF₂CF(CF₃)O)_{r′}—(CF₂CF₂O)_{s′}—(CFX′^{I}O)_{t′}—CFX′^{I}— (b′)
where X′^{I} is —F or —CF₃; r′, s′ and t′ are numbers such that (r′+s′) is between 1 and 50, the ratio t′/(r′+s′) is between 0.01 and 0.05, (r′+s′) being different from zero, and the number-average molecular weight is between 500 and 10,000;
—CF(CF₃)(CFX′^{I}O)_{t′}(OC₃F₆)_{u′}—OR′_{f}O—(C₃F₆O)_{u′}(CFX′^{I}O)_{t′}CF(CF₃)— (c′)
where R′_{f} is a C₁-C₈ perfluoroalkylene; (u′+t′) is a number such that the number-average molecular weight is between 500 and 10,000; and t′is optionally equal to zero; X′^{I} is —F or —CF₃;
—CF₂CF₂O—(CF₂(CF₂)_{x′}CF₂O)_{v′}—CF₂CF₂ (d′)
where v′ is a number such that the number-average molecular weight is between 500 and 10,000, x′ is an integer equal to 1 or 2; and
—CF₂CH₂—(OCF₂CF₂CH₂O)_{w′}—OR′_{f}O—(CH₂CF₂CF₂O)_{w′}—CH₂CF₂ (e′)
where R′_{f} is a C₁-C₈ perfluoroalkylene; w′ is a number such that the number-average molecular weight is between 500 and 10,000.

8. The method according to claim 1, wherein component b) has the formula (I):
T-(Rₕ)_{y1}R_{y}(Rₕ)_{y1′}-T′ (I)
in which
T, T′, which are identical or different, are functional groups,
Rₕ is a linear or branched C₁-C₂₀ alkylene chain, or C₃-C₂₀ cycloaliphatic chain, or an aromatic group, optionally substituted;
R_{y} is a C₃-C₂₀ cycloaliphatic chain, optionally substituted, a linear or branched C₁-C₂₀ alkylene chain, one or two aromatic groups, optionally substituted, optionally condensed, optionally bound to alkylene segments containing a number of carbon atoms between 1 and 12, optionally containing heteroatoms;
y₁, y_{1′}, which are identical or different, are integers equal to 0 or 1.

9. The method according to claim 8, wherein the component b) is selected from the following compounds:
(A) amines of formula NHR_{3′}—(Rₕ)_{y1—}R_{y—}(Rₕ)_{y1′}—NHR₃ (1)
in which y1 and y1′ are integers equal to 0 or 1,
R₃, R_{3′}, which are identical or different, are H, linear or branched C₁-C₅ alkyl radical,
Rₕ is a linear or branched C₁-C₂₀ alkylene chain, or C₃-C₂₀ cycloaliphatic chain, or an aromatic group, optionally substituted; and
R_{y} is a C₃-C₂₀ cycloaliphatic chain, optionally substituted, a linear or branched C₁-C₂₀ alkylene chain, one or two aromatic groups, optionally substituted, optionally condensed, optionally bound to alkylene segments containing a number of carbon atoms between 1 and 12, optionally containing heteroatoms;
(B) isocyanates of formula OCN—R_{y}—NCO
in which R_{y} is as defined in formula (I), is a C₃-C₂₀ cycloaliphatic chain, optionally substituted, a linear or branched C₁-C₂₀ alkylene chain, one or two aromatic groups, optionally substituted, optionally condensed, optionally bound to alkylene segments containing a number of carbon atoms between 1 and 12, optionally containing heteroatoms;
(C) esters of formula ROOC—R_{y}—COOR (2)
in which
R is a linear or branched alkyl radical with from 1 to 5 carbon atoms, anhydride; and
R_{y} is a C₃-C₂₀ cycloaliphatic chain, optionally substituted, a linear or branched C₁-C₂₀ alkylene chain, one or two aromatic groups, optionally substituted, optionally condensed, optionally bound to alkylene segments containing a number of carbon atoms between 1 and 12, optionally containing heteroatoms;
(D) alcohols of formula HO—R_{y}—OH (5)
in which Ry is a C₃-C₂₀ cycloaliphatic chain, optionally substituted, a linear or branched C₁-C₂₀ alkylene chain, one or two aromatic groups, optionally substituted, optionally condensed, optionally bound to alkylene segments containing a number of carbon atoms between 1 and 12, optionally containing heteroatoms;
(E) anhydrides of following formula: 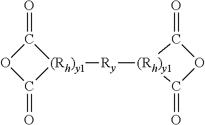
in which
y1 and y1′ are integers equal to 0 or 1;
Rₕ is a linear or branched C₁-C₁₀ alkylene chain, or C₃-C₁₀ cycloaliphatic chain, or an aromatic group, optionally substituted; and
R_{y} is a C₃-C₂₀ cycloaliphatic chain, optionally substituted, a linear or branched C₁-C₂₀ alkylene chain, one or two aromatic groups, optionally substituted, optionally condensed, optionally bound to alkylene segments containing a number of carbon atoms between 1 and 12, optionally containing heteroatoms.

10. The method according to claim 1, wherein the additive has a molecular weight between 3,000 and 200,000.

11. A method for the preparation of masterbatches of hydrogenated resins, comprising using a fluorinated thermoplastic additive,
said additive comprising (per)fluoropolyether segments and non-fluorinated hydrogenated chain segments, said non-fluorinated hydrogenated chains having at least one crystalline phase that melts at a temperature of at least 25° C. the additive being obtainable by a reaction of polycondensation, polyaddition in stages, or polyaddition of the following components:
a) a (per)fluoropolyether having two functional end groups able to give reactions of condensation or addition with hydrogenated co-reactants; and
b) a hydrogenated co-reactant containing alkylene, cycloaliphatic, aromatic chains, and having functional end groups capable of reacting with the functional groups of the (per)fluoropolyether a), to give polymers having at least one crystalline hydrogenated phase having a melting point of at least 25° C.

12. Masterbatches of hydrogenated resins comprising one or more additives,
said additive comprising (per)fluoropolyether segments and non-fluorinated hydrogenated chain segments, said non-hydrogenated chains having at least one crystalline phase that melts at a temperature of at least 25° C., the additive being obtainable by a reaction of polycondensation, polyaddition in stages, or polyaddition of the following components:
a) a (per)fluoropolyether having two functional end groups able to give reactions of condensation or addition with hydrogenated co-reactants; and
b) a hydrogenated co-reactant containing alkylene, cycloaliphatic, aromatic chains, and having functional end groups capable of reacting with the functional groups of the (per)fluoropolyether a), to give polymers having at least one crystalline hydrogenated phase having a melting point of at least 25° C.

13. Masterbatches according to claim 12, wherein the hydrogenated resins are polymers obtained by polyaddition, by polyaddition in stages, or by polycondensation.

14. Masterbatches according to claim 13, wherein the hydrogenated resins are selected from the group consisting of polyolefins, polyurethanes, polyesters, polyamides, polyamide-imides, and polyimides.

15. Manufactured articles obtainable from the masterbatches according to claim 12.
